(19) United States
(12) Patent Application Publication
(10) Pub. No.: US 2005/0032530 A1
(43) Pub. Date: Feb. 10, 2005

(54) Wireless landmarking

(75) Inventor: Martin Xavier Pandipillil Antony, Cochin (IN)

Correspondence Address: Martin's Electronic Devices and Instruments, 39/2067,Manikkiri Cross Road, Cochin, 682016, IN

(73) Assignee: Mr. Thomas Jude, Cochin (IN)

(21) Appl. No.: 10/411,988

(22) Filed: Aug. 6, 2003

(51) Int. Cl. H04B 1/00; H04Q 7/00

(52) U.S. Cl. 455/456.3

(57) ABSTRACT

Wireless Land marking provides complete solution in identifying places electronically. For its working, short range (around 100 meters) Data Transmitters should be placed at various places as per requirement. These are powered with small solar cells with appropriate battery back up. These Data Transmitters will transmit identification of landmark sav the name of a place continuously. The transmission will be in ASCII format with a special protocol for data integrity checking. A low sensitivity Data Receiver is sufficient to receive this, which is to be placed at each vehicle. As the vehicle approaches the Data Transmitter, the Data Receiver would receive that data and a micro controller processes this data. This has many features including display/announcing, route map, pre-programmed remainder buzzer, and lot more. Such systems impose its powerful impact on its usefulness.

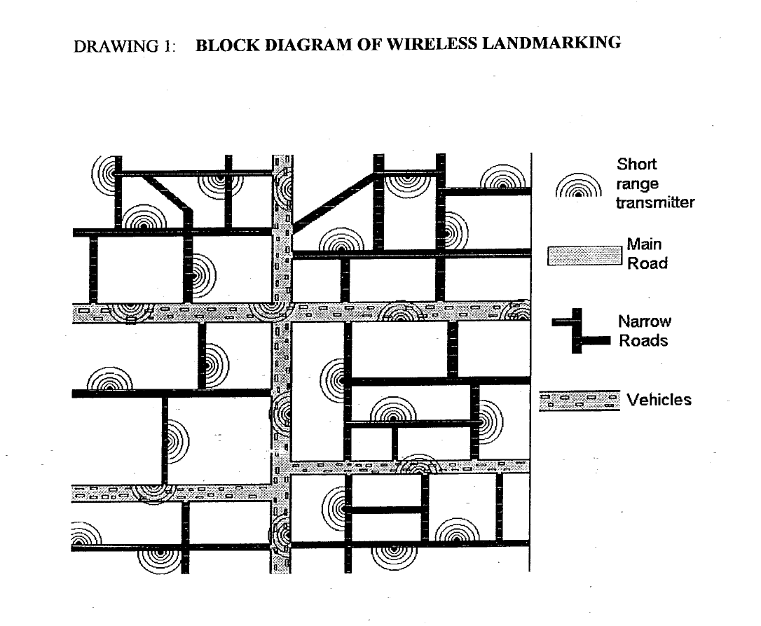

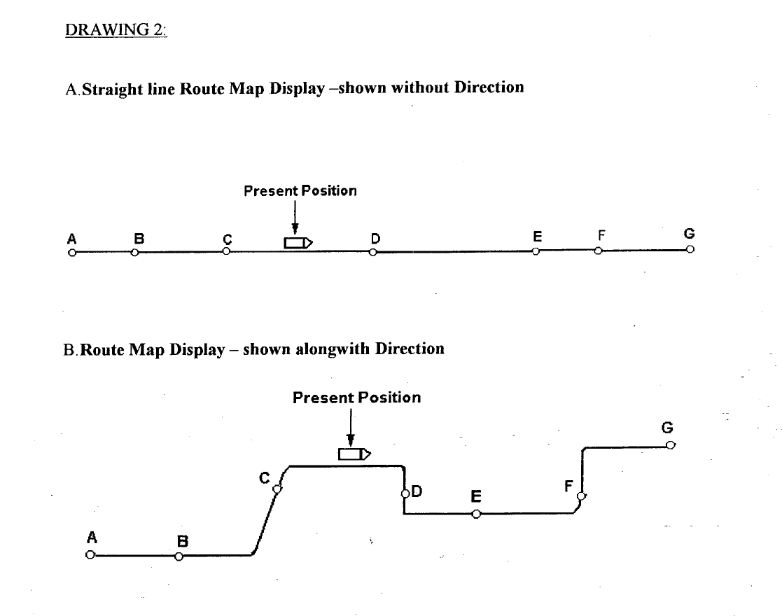

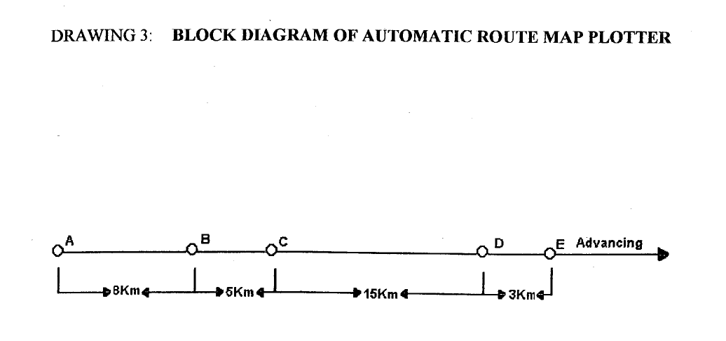

### BACKGROUND OF THE INVENTION

While traveling, especially in unfamiliar places, most of us may have come across situations where it is very difficult to locate a place. For example when driving a car to an unfamiliar place we need to continuously watch and read the sign boards or stop the car and ask people. This is not at all practical in places/situations like high traffic area, raining or snow falling time, place of unfamiliar language, fast driving highways etc. This will negatively effect the ease, comfort and fastness of driving. In this situation imagine about an electronic device inside the car that will display the name of places through which we are passing by.

In another similar situation, for example, when we are traveling in a train or bus we need to continuously watch the name boards at each station or ask others. The situation become worse in night journey or traveling in an AC compartment. At sleeping time the chance to miss a station is more even if in a familiar route. In this situation imagine about an electronic device in our pocket that will give a reminder beep when a pre-programmed place is reached.

The above said problems happen because we are still depending on conventional methods of identifying, land marking or locating places. In this situation the importance of the invention ‘wireless landmark’ come. In short, ‘Wireless Land Marking’ is a methodology, to provide electronic identification of places, which are readable electronically and wirelessly. Once we implement this idea the applications are vast. For example:—Location displays with/without announcer, pre-programmable personal location reminder, route map displays, electronic time stamp punching for transport service vehicles etc.

### SUMMARY

Object:

Identify the places electronically and producing associating accessories to achieve that.

As the name suggests, Wireless Land marking provides complete solution in identifying places electronically.

Short range (around 100 meters) Data Transmitters should be placed at various places as per requirement. These are powered with small solar cells with appropriate battery back up. These Data Transmitters will transmit identification of landmark say the name of a place, continuously. The transmission will be in ASCII format with a special protocol for data integrity checking. A low sensitivity Data Receiver is sufficient to receive this, which is to be placed at each vehicle. As the vehicle approaches the Data Transmitter, the Data Receiver would receive that data and a micro controller processes this data.

This has many features including display/announcing, route map, pre-programmed remainder buzzer, and lot more. Such systems impose its powerful impact on its usefulness.

Being a unique and useful innovation, this could give a new direction to the electronic industry.

### DETAILED DESCRIPTION OF THE INVENTION

The following specification describes the nature of the invention Wireless Landmarking. Here is a description to the various applications offered by this invention.

1.Alpha Numberic Display/Announcement in Car

This accessory helps in identifying the locations during a car travel through alphanumeric display.

To facilitate this service short range (around 100 meters) Data Transmitters should be placed at various places as per requirement say in between 1 Km in Highways and 250 Meter in crowded cities. These are powered with small solar cells with appropriate battery back up. These Data Transmitters will transmit identification of landmark say the name of a place, continuously. The transmission will be in ASCII format with a special protocol for data integrity checking. Low sensitivity data receivers are sufficient to receive the data transmitted by Data Transmitters.

This concise of a Data Receiver Unit which has to be connected to a micro controller and associated display unit. This unit will receive the data transmitted by Data Transmitters, while passing through these points. Once the data is catch by the receiver, it will display the details like name of place through alphanumeric display. The entire unit works wirelessly.

While driving one could concentrate on driving only, as the landmark identification will display/announce when new landmark is updated continuously/instantaneously inside vehicle. The previous location display will remain there until the data receiver identifies the next location. This facilitates the user to identify the location even after covering it. There is also an option of switching off the announcing.

Thanks to this system, which provides a perfect solution for land identification electronically.

2. Route Map Display in Train/Bus

Aiming more informative about the location, this would provide the best solution.

For it's working, a Map Display Unit, which contains a front end Data Receiver is necessary. This unit will receive the data transmitted by Data Transmitters placed at predetermined different locations, while passing through these locations. This incorporates with a route map display in Compartment/Bus with important places marked in it.

Once the vehicle is in motion, according to the data received the map will show the progress of its journey, showing stations between starting and finishing point and marking present location of the bus/train.

Different drawings are attached showing the Route Map Display in straight line without direction and with direction.

Refer Drawing 2

3.Automatic Route Map Plotter

Though travelling to a new place is exciting, one should be extremely cautious during the journey through unknown routes. Here is a complete electronic solution for this.

Data Transmitters should be placed at different locations say 250 meters apart, which will continuously transmit landmark details like name of place. This is equipped with proper battery back up. The signals sent by Data Transmitters will catch by the low sensitivity Data Receiver placed in the vehicle.

For it's functioning, the system incorporates a graphic display and associated circuit, which is connected from the front end Data Receiver. The unit is connected with the Speedo meter so that the distance traveled is also measured.

During the travel, as the vehicle approaches the Data transmitters, graphic display unit will start displaying the places as well as the distance travelled in Kilometers by working in association with Data Receivers. (See Drawing 3). This display will continue until the destination is reached. So during return trip there won't be any difficulty in tracing the routes covered.

Both the transmitters and the graphic display unit are micro controller based. So this could be improved further by connecting to an electronic compass or GPS (Geo Positioning Satellite). This will help in retrieving the road map with direction along with display of the places passed by.

4.Electronic Punching for the Bus

In road transportation system, it is important to keep track of exact timings of its services. Manual punching is inconvenient, but it is a necessity. If we can have information on vehicle identity and timings without disturbing the journey, that would provide the best solution.

In most of the places manual punching system has number of punching posts situated at different places of city where one person has to go and sign the card. This card will be containing all details about bus including the bus number, time of crossing the post, etc. The drawback of this system is that one person has to get down and go for signing the same at each post. In addition, this is time-consuming and error prone process especially when many vehicles pass checking points simultaneously. Hence the system cannot cater to the present day needs. Overall the effectiveness and aim of this system still remains useless. In a city where hundreds of buses gridlock the roads every day, the service provided by manual punching system may not be sufficient and bus network may remain agonizingly slow and uncomfortable.

Here, Electronic Punching system comes into picture. The salient feature of the new system is the way in which various buses are connected without disturbing their Journey.

The system consists of a Data Receiver unit connected in each bus. Data Transmitters placed at various checking points at road will transmit the identity continuously and this is received by the Data receiver. Computer should be placed at finishing point.

When the bus reaches the destination, through these landmarks, computer sends a request. Once the request is received, the bus will transfer all data to the computer wirelessly. The system can make a detailed report about the journey showing the bus number, time of passing each posts etc.

There are several advantages offered by this system. There is enormous time saving, accuracy, enables maximum number of vehicles to pass by simultaneously etc.

5. Station Name Announcer Cum Display Unit

People rely mostly on train/bus journey, which is the cheap and convenient mode of transport. We can further, improve the facilities as detailed hereunder. Identifying a station is always in demand. Every passenger would hate to miss a chance of identifying a station he passes by. At present we have certain limitations in identifying stations. In most of the stations the nameplates shown are not visible due to poor lighting/ small size, especially during night travel. If the train is running fast, it is difficult to read the nameplate through window. The situation is not different in A/C compartments. Another major inconvenience is that each passenger has to watch continuously for the desired station.

As the name indicates, the system ‘Station Name Announcer cum Display Unit’ has a facility of display/announce station name when new landmark is updated continuously/instantaneously, in different languages say two or three, and display it on compartments. The previous location display will remain there until the data receiver identifies the next location. This facilitates the user to identify the location even after covering it.

The technology, which is prevalent in the present situation, necessitates:
1. ID Transmitter unit
2. Compartment Announcement/Display unit

The ID transmitter unit may be installed at important stations, and the compartment announcement unit shall be fixed in each compartment. This ID transmitter unit will continuously transmit the station identification (Digital ID) and the passengers will get the announcement once the Compartment announcement unit catches the signals. Compartment announcement unit will catch the signals transmitted by station ID transmitter within a radius of 500 meters.

The passenger will have the facility of doing his personal activities without worrying about the identity of station passing by. This is a unique design. Since both the transmitter and the announcer are microcontroller based, many new features could be added as per requirements.

6. Pre-Programmable Location identifying Buzzer and Display Unit

Every passenger would have experienced the difficulty in identifying a place during travel especially traveling through a new place. In addition to that if we travel in a train we need to watch the name boards at each station or ask others. The situation becomes worse during night journey or in AC compartments. While sleeping, the chance to miss a station is more even in a familiar route.

This new system will be useful in overcoming these drawbacks. Data Transmitters will transmit data from predetermined places. This data will be containing details about the place. A low sensitivity Data Receiver could receive the location details from that.

The facility includes a provision of programming the device to set the appropriate Location the passenger wants. When the point is approached the system will ring a buzzer, alerting him.

This product has got many advantages. Presently the passenger has to watch continuously whether the destination has reached. This is very inconvenient especially during night travel. This new system rectifies drawback. Suppose the passenger is travelling through the points A,B,C,D,E and F with a destination say point D. He can set the buzzer to ring at point C so that he can get ready just before reaching the destination. This facilitates the passenger to travel without worrying about missing the destination and have a peaceful journey.

This product of course is a great relief to all especially to night travelers

1. Wireless land marking, has the following advantages compared to gps based station/town/city name identification:
given below is a listing of the advantages of Wireless Landmark over GPS Method.
GPS Method Vs Wireless Landmark

| | GPS Method | Wireless Landmark |
|---|---|---|
| 1 | Complex Receiver design leads | Simple Receiver design, low Cost |
| | to high Receiver Cost | |
| 2 | Requires a separate antenna | Does not require a separate antenna |
| | fixed outside and in line-of-sight | and does not involve the |
| | with the satellite, for tracking | inconveniences of line-of-sight |
| | the satellite, leading to | installation. So, receiver is easy-to- |
| | complexities in installation and | install and can be placed anywhere |
| | possibilities of unreliable | irrespective of any line-of-sight. |
| | working. | |
| 3 | Satellite is not traceable during | Will work in all regions |
| | rains, snows, under trees/ | irrespective of rains, snows, under |
| | buildings, inside vehicles, in | trees/buildings, inside vehicles, |
| | shadows of buildings (urban | urban areas, etc. |
| | areas), etc. So, it will not work | |
| | in these situations. | |
| 4 | Names of all places need to be | Location information is not stored |
| | entered into the memory of all | in the receivers; it is stored in the |
| | receivers. Hence, if a receiver is | landmark itself. Hence, if a |
| | moved into a new region/ | receiver is moved into a new |
| | country, the details (location | region/country, it will display the |
| | names) of that area need to be | details (location names) of that |
| | entered into the receiver. | area. |
| 5 | New/renamed location names | New/renamed location names are |
| | need to be fed again into all | also not stored in the receivers; |
| | receivers. | they are stored in the landmark |
| | | only. So, any change in location |
| | | names does not affect the working |
| | | of existing receivers. |
| 6 | GPS enabled mobile phones are | Wireless landmark enabled mobile |
| | not totally practical. i.e. their | phones are more practical as they |
| | locations are not identifiable in | will work in all places, e.g. inside |
| | areas that cannot be tracked by | buildings, vehicles, etc. |
| | satellite, e.g. inside buildings, | |
| | vehicles, etc. | |
| 7 | GPS method needs satellites. | Wireless Landmark, having no |
| | | need of satellite makes it simple. |
